(19) United States
(12) Patent Application Publication
(10) Pub. No.: US 2012/0330688 A1
(43) Pub. Date: Dec. 27, 2012

(54) BENEFIT PAYMENT METHOD AND SYSTEM

(75) Inventors: Edwin M. Goldsmith, Bryn Mawr, PA (US); Marcia W. Goldsmith, Bryn Mawr, PA (US); Louis M. Heidelberger, Villanova, PA (US)

(73) Assignee: Edwin Goldsmith

(21) Appl. No.: 13/279,377

(22) Filed: Oct. 24, 2011

Related U.S. Application Data
(60) Provisional application No. 61/406,000, filed on Oct. 22, 2010.

(51) Int. Cl. G06Q 40/08; G06Q 10/06; G06Q 40/00

(52) U.S. Cl. 705/4; 705/39; 705/322

(57) ABSTRACT

A funding system for post retirement benefits is provided that includes implementing first and second life insurance policies each of which pays a benefit. The owner enters into said first and second life insurance policies wherein the first insurance policy provides a benefit for that period of time that corresponds to the pre-retirement of an employee and the second life insurance policy pays a benefit only during that period that corresponds to the post retirement period of that employee. The first and second life insurance policies are structured such that the second policy expires upon death of the insured. The owner is not required to accrue any liability for the death benefit of the insured. Payments are effected of said first and second life insurance policies in said first period.

### RELATED APPLICATION

This application claims priority of U.S. Patent Application Ser. No. 61/406,000, entitled BENEFIT PAYMENT METHOD AND SYSTEM, filed Oct. 22, 2010, the entire disclosure of which is hereby incorporated by reference as if being set forth in the respective entirety herein.

### FIELD OF THE INVENTION

The present invention relates generally to funding benefits and more particularly, post retirement benefits and methods and systems of implementing and managing same. Even more particularly, the invention relates to a coupled set of life insurance policies that operate over separate time periods.

### BACKGROUND

Institutions often enter into deferred compensation agreements with selected employees as part of executive compensation and retention programs. These agreements are generally structured as nonqualified retirement plans for federal income tax purposes and are based upon individual agreements with selected employees. Institutions purchase Company owned life insurance (“COLI”) in connection with many of these agreements. COLT may produce attractive tax-equivalent yields that offset some or all of the costs of the agreements.

Benefit plans may include obligations under a type of deferred compensation agreement commonly referred to as a revenue neutral plan or an indexed retirement plan (collectively referred to as BPs), which are one type of deferred compensation agreement that institutions enter into with selected employees. BPs are typically designed so that the spread each year, if any, between the tax-equivalent earnings on the COLI covering an individual employee and a hypothetical earnings calculation is deferred and paid to the employee as a postretirement benefit. This spread is commonly referred to as “excess earnings.” The hypothetical earnings are computed based on a pre-defined variable index rate (e.g., cost of funds or federal funds rate) times a notional amount. The notional amount is typically the amount the institution initially invested to purchase the COLI plus subsequent after-tax benefit payments actually made to the employee. By including the after-tax benefit payments and the amount initially invested to purchase the COLI in the notional amount, the hypothetical earnings reflect an estimate of what the institution could have earned if it had not invested in the COLI or entered into the BP with the employee. Each employee's BP may have a different notional amount upon which the index is based. The individual BP agreements also specify the retirement age and vesting provisions, which can vary from employee to employee.

A BP agreement typically requires the excess earnings that accrue before an employee's retirement to be recorded in a separate liability account. Once the employee retires, the balance in the liability account is generally paid to the employee in equal, annual installments over a set number of years (e.g., 10 or 15 years). These payments are commonly referred to as the “primary benefit” or “preretirement benefit.”

An employee may also receive the excess earnings that are earned after retirement. This benefit may continue until his or her death and is commonly referred to as the postretirement benefit. This benefit may be paid annually, once the employee is retired. Companies purchase life insurance for various reasons that may include protecting against the loss of “key” employees, funding deferred compensation and postretirement benefit obligations, and providing an investment return. One form of this insurance is split-dollar life insurance. The most common type of arrangement is the split-dollar life insurance arrangement. Here the company generally owns the policy and splits the proceeds with its employees and/or their heirs.

The employee's portion of the death benefits is commonly based upon: the amount that exceed the gross premiums paid by the employer; the amounts that exceed the sum of the gross premiums paid by the employer and an additional fixed or variable investment return on those premiums; the net insurance at the date of death (e.g., the face amount of the death benefit under the policy, less the cash surrender value); or the amount equal to a multiple of the employee's base salary at retirement or death.

Deferred compensation agreements, including BPs, may include non-compete provisions or provisions requiring employees to perform consulting services during postretirement years. If the value of the non-compete provisions cannot be reasonably and reliably estimated, no value should be assigned to the non-compete provisions in recognizing the deferred compensation liability. Institutions should allocate a portion of the future benefit payments to consulting services to be performed in postretirement years only if the consulting services are determined to be substantive. Factors the agencies would consider in determining whether postretirement consulting services are substantive include, but are not limited to, whether the services are required to be performed, whether there is an economic benefit to the institution, and whether the employee forfeits the benefits under the agreement for failure to perform such services.

An issue with respect to the foregoing involves the tax aspects with respect to whether the institution must accrue the liability for the above undertakings and adjust retained earnings. It may also trigger disclosure requirements and compliance with various other regulations.

A further issue is that certain pension and benefit plans use a discount rate which is not realistic or achievable in the present times and accordingly there may be a risk that the pension and/or benefit plan will not be properly funded in the sense that it will be sufficient to pay out the anticipated benefits.

These and other disadvantages have not been heretofore addressed. There also remains a need in this art for a method and system that addressed these issues and additionally may be computer implemented. There remains a need for a cost effective method and system which is simplistic in nature, yet offers a flexible, customizable design to a benefit plan that has not yet been addressed.

Other needs and advantages in accordance with the present invention are set forth herein and/or will become evident from a complete reading of the patent application.

### SUMMARY OF THE INVENTION

In accordance with one embodiment related to post retirement benefits, a method and system may be implemented by providing a funding system that includes a series of contracts, financial instruments or a single instrument which has a series of different components that include the foregoing contracts, instruments and/or life insurance policies. For illustrative purposes, this invention is described in terms of first, second and up to “N” life insurance policies, however, other financial instruments and/or or contracts can be used in place of or in addition to life insurance or in combination with each other, or otherwise. One embodiment includes implementing first and second life insurance policies each of which pays a benefit; entering into said first and second life insurance policies by the owner wherein the first insurance policy provides a benefit for that period of time that corresponds to the pre-retirement of an employee and the second life insurance policy pays a benefit only during that period that corresponds to the post retirement period of that employee; structuring the first and second life insurance policies such that the second policy expires upon death of the insured and the owner is not required to accrue a liability for the death benefit of the insured; and effecting payments of said first and second life insurance policies in said first period, wherein the owner of the life insurance policy is entitled to the benefit at the beginning of the second period based upon the death of the insured.

In accordance with another embodiment a funding method may further include supplying the requisite variables for entry into a computer readable medium, whereby instructions operate on said variables to determine the type, cost and terms for the life insurance policies that will produce the desired benefit. In accordance with another embodiment a funding method may be one where the type of life insurance policies are selected from the group consisting of term insurance, whole life insurance, variable life insurance, split dollar life insurance and combinations thereof. Further, the benefits may be paid to the employer or at least a portion of the benefits may be pooled by the employer to fund post retirement benefits of retired employees not including the insured. Additionally, a portion of the benefits may be paid to the employee or his heirs and the remainder to the employer.

In accordance with another embodiment of the present invention, a method and system may be implemented to pay future benefits by coupling a first and second life insurance policy wherein the first policy provides a benefit for a first period and a second policy provides a benefit for a second period; wherein the second policy is in force in the first period but does not pay a benefit until the second period, further providing, that should the first life insurance policy mature upon the death of the insured in the first period, the second policy expires. In this method the second policy may be term life insurance; the first and second life insurance policies may both be term insurance policies; the second policy may continue to be in force upon the expiration of the first period; the first life insurance policy may expire at the end of the first period; or at least one of the life insurance policies may mature in either the first or second periods. Additionally, the beneficiary of the life insurance policy may be the owner; the owner of the life insurance policy may be an employer; the owner of the life insurance policy may be an employer and the beneficiary may be the employee's heir(s); the owner of the life insurance policy may be an employer and the beneficiary may be both the employer and the employee's heir(s); or the owner of the life insurance policy may be an employer and the beneficiary may be the employer, wherein the benefits may be used to fund post retirement benefits of other employees of the employer. Other permutations and combinations may be where: the benefit may be paid in the second period; the benefit may be used to fund a post retirement benefit; the benefit may used to fund a pension plan; the benefit may be used to fund an executive compensation package; the executive compensation package may be a post retirement package that may include non-compete provisions; the executive compensation package may require employees to perform consulting services during postretirement years; the first insurance policy may generate earnings that exceed the cost of the policy; the earnings may be accrued in the first period; the earnings may be paid to the owner of the policy; the earnings may be paid to both the owner and the beneficiary of the policy; the earnings may not be paid until commencement of the second period; the earnings may be paid over a set term of years in the second period; the earnings may be paid over the life of the beneficiary; or at least a portion of the earnings may be paid in the first period and additional payments may be generated by the life insurance policies in the second period; a payment in additional to that which is paid in the first period may be paid in the second period; or where the owner of the life insurance policy may have no liability under the life insurance policies to the insured.

In accordance with another embodiment, a computerized system for generating a benefit plan based upon preferences of a benefit plan participant and presenting via a computerized network to its user, a benefit plan for said participant is provided and includes: prompting the user for at least one benefit plan parameter via at least one computer interface to formulate a benefit request; interfacing with information selected from the group consisting of the benefit request, employee data, employer data, mortality data base, contracts data base or combinations thereof, to obtain data for input into benefit design software; applying a plurality of benefit design rules to the at least one benefit parameter and said resultant input from said interfacing step; and generating a benefit design plan based upon the performance of all or a portion of the foregoing steps. These steps may further include providing administrative software for interfacing with said contracts data base, employer data base and employee database, wherein the individual benefit plans are administered, wherein said administrative software interfaces with the contracts in said contracts data base for purposes of making and receiving payments from said contracts and wherein said administrative software may further include interfacing with the beneficiaries of said contracts.

Other objects and features of embodiments of the present invention will become apparent from consideration of the following description taken in conjunction with the accompanying drawings. As will be appreciated, the invention is capable of other and different embodiments, and it s several details are capable of modification in various respects, all without departing from the spirit of the invention. Accordingly, the drawings and description of the preferred embodiment are to be regarded as illustrative in nature and not restrictive.

### BRIEF DESCRIPTION OF THE DRAWINGS

FIG. 1 is a block diagram of a preferred embodiment of the system of the present invention;

FIG. 2 is a bock diagram of the benefit system software of the present invention; and

FIG. 3 is a flow diagram detailing the functionality of the system of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in a benefit structuring system and method. Those of ordinary skill in the art will recognize that other elements are desirable and/or required in order to implement the present invention. However, because such elements are well known in the art, and because they do not facilitate a better understanding of the present invention, a discussion of such elements is not provided. Additionally, it should be noted that, although the invention disclosed herein may make reference to specific benefit structures and products, the invention may be applied in substantially the same manner as disclosed herein to numerous benefit structures. Further, although certain examples of the present invention are discussed with specific reference to insurance, it will be apparent to those skilled in the art that the present invention may be used for all benefit types which may utilize various financial instruments and products which may or may not include some insurance products. The disclosure herein below is directed to all such variations and modifications to benefit structures known to those skilled in the art.

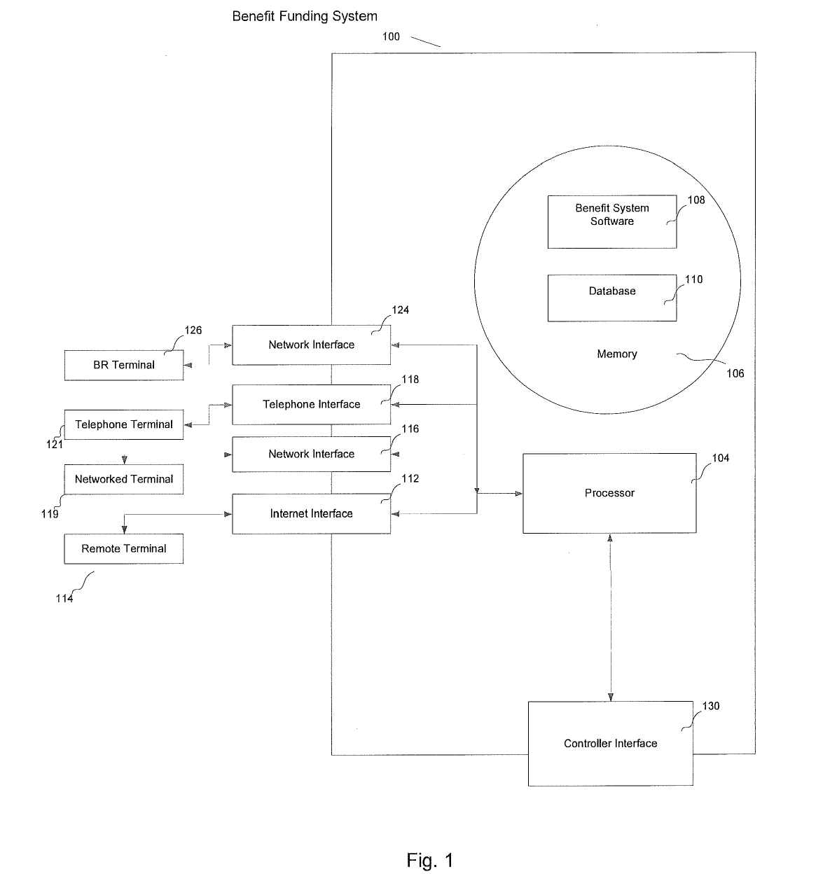

Referring now to FIG. 1, an embodiment of the present invention directed to automated process for benefit structuring is illustrated. As shown in FIG. 1, a benefit funding system (hereinafter “BFS”) 100 includes a computer 102, which may be a mainframe computer, a minicomputer, a microcomputer, or other general purpose computing machine. The computer may include at least one processor 104 and a memory 106, which may be temporary memory, such as random access memory, permanent storage, such as a hard drive, or a combination of temporary memory and permanent storage. A Benefit System Software 108 [hereinafter “BSS”] is stored in memory. Alternatively, BSS 108 may be stored on a removable computer readable medium, such as a CD-ROM (not shown).

Memory 106 may be used to store data regarding each benefit structuring. This information may be stored in a database 110 within memory 106. Database 110 may be a database managed by a database management system, such as Informix, Oracle, or Sybase.

Computer 102 may have several interchanges, such as interfaces, for communicating with other entities. These interfaces include an internet interface 112 for communicating with customers 114 accessing BFS 100. Also, included is a network interface 116 allowing networked computers to access BFS 100. A network computer 118 may be located in a facility operated in conjunction with BFS 100, such that benefits customers may access the system without having Internet access. The system may have a telephone interface 120, such that customers may dial into the system to access BFS 100. The system my have a benefits representative (BR) interface 122 so that salespeople 124 may access the system and utilize the automated processing of BFS system 100. Further, the system may include a remote interface, which allows a BR at a remote location to access BFS 100. The system may include a non-interface, which allows a BR to operate BFS 100 in stand-alone mode. In addition, BFS system 100 may include at least one third party interface, for third parties such as insurance companies and other relevant institutions. BFS 100 may include an interface that invokes a BR or underwriter interface 130 (herein below called the Controller interface) to become involved in a benefit structuring when invoked by a customer. There may or may not be limitations placed on the invocation of the Controller interface, such as time limitations or multiplicity limitations, and the placement of such limitations on invocation will be understood to those skilled in the art.

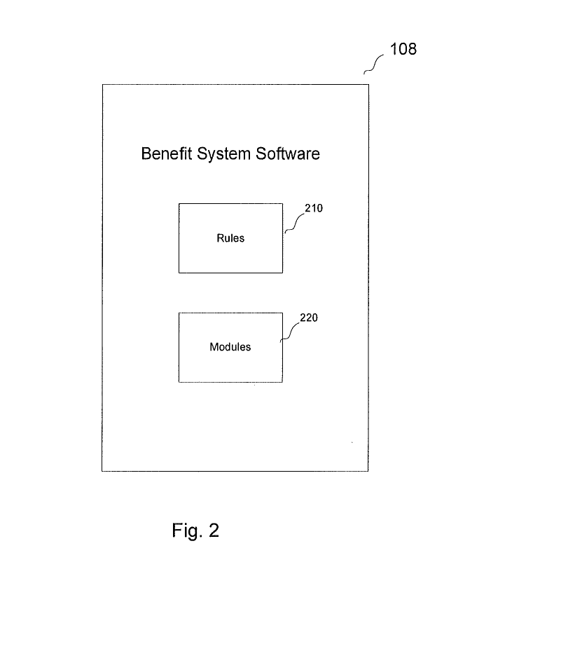

FIG. 2 illustrates an embodiment of BSS 108 of the present invention. BSS 108, resident on BFS 100, may include rules 210, and modules 220. An example of rules 210 may be own products exclusionary rules and third party, such as independent investors or actuaries, exclusionary rules, for application to the information entered by a customer in a benefit structuring. Another example of rules 210 may be pricing and risk rules, such as compensating factors rules, which provide rules for adjusting the eligibility of a customer based on ancillary factors such as time on a job, disposable income, health, medications and such other rules regarding changing benefit and customer preferences when recalculating the benefit design. A further example of rules 210 may be edit preference rules including interactions for proposals and counter-proposals of varied benefit deal preferences between BR/customer 114 and BFS system 100 (for example, a benefits representative/customer may express a desire for a larger benefit, and/or a benefit that extends over a longer time period, which is countered by BFS 100 by requiring additional insurance or more extensive financial services instruments or contracts in either the first, second or an additional “N” periods). BSS may include various benefits rules, which identify the benefits of a specific product for a BR/customer.

BSS may include explanation rules. Explanation rules are provided to bridge the gap between the benefit, such as a term insurance policy, offered, and the benefit BR/customer 114 requested and/or expected. Explanation rules determine what explanation should be provided to a BR/customer regarding an acceptance or refusal of, for example, the insurer, to offer a product. The explanations provided are audience specific. For example, the explanations given directly, via a computer screen, to a customer in an internet based deal structuring, will be directed to a more inexperienced deal structuring audience, while the explanation provided to a BR to, in turn, be given to a customer, may be directed to a more experienced benefit-structuring audience. Further, different explanations directed only to BR's allow an offeror to prevent disclosure to the public, and, specifically, to competitor offerors, of, for example, underwriting and offering rules. Generation and storage of explanations may provide an offeror with a record of reasons for benefit refusal and/or restructuring, should a customer later argue that refusal was improper, and may provide an offeror with a record of reasons for benefit acceptances, thus helping to provide an empirical database of common reasons for acceptance and refusal.

BSS may include stipulation rules. Stipulations may include requirements to be met by customer 114 before the finalization of the benefit design. Stipulations may include, for example, that additional documentation be provided before an insurance policy or policies financial services instrument(s) or contract(s) may be issued.

BSS 108 may include instruction modules 220 to allow for the saving of a benefit structuring record before the entirety of necessary information, such as customer information, has been obtained. Thereby, a benefit structuring may be saved, and returned to and accessed by the same customer, or a BR, for completion at a later point. The generation of security measures for preventing unauthorized access, by anyone other than the same customer, or by a BR, to the stored deal structuring, and retrieval of the stored deal structuring, may also be included in the “stop and save” instructions of BSS.

BSS 108 may include a “status check” module 220. Such a module may allow for the checking of status on certain elements of a deal, such as the status of certain stipulations required in a benefit design.

The description hereinabove is directed toward interaction between customers and BFS 100, and BR serving as intermediaries between customer 114 and BFS 100. A Controller module 220 of BFS may allow a BR to generate a benefit structuring record for a customer, and access and edit the record, and may provide tools for assisting a customer in understanding the determinations generated by BFS system 100.

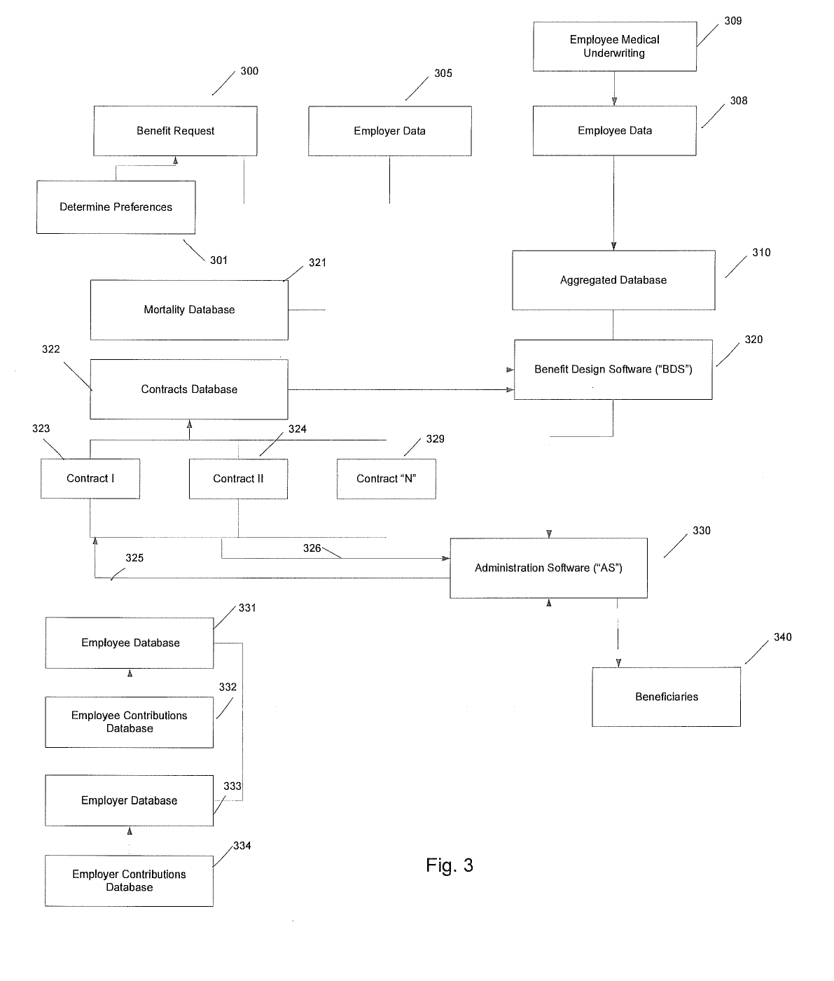

Referring now to FIG. 3, a method in accordance with the present invention is illustrated. A benefit request 300 may be made directly by a customer, an insurance agent, employer, employee or benefits specialist that may be any one of the above identified requester(s). The request may be made utilizing any one of internet interface 112, network interface 116, telephone interface 118 or BR terminal 126 through network interface 124. The benefit request 300 may include predetermined preferences 301 such as, for example, the COLI investment in mn, pre-tax cost of funds, net crediting rate (COLI yield), leverage ratio, tax rate, discount rate, funding period, benefit per year, benefit liability at retirement, benefit service cost and the like as may be necessary in accordance with the benefit plan design.

A benefit request may involve many different parameters, which vary based upon the stature of the executive for which the request is made. It may take the form of guaranteed postretirement payments that may be a sum certain for a given period of time, the life of the employee or variable amounts structured for tax and other purposes. Post retirement consulting contracts are also among the postretirement benefits that may be offered. These benefits may be funded by various financial instruments, which may include various insurance products or combinations of financial instruments, insurance policies, annuities and the like. Benefit request 300 may include financial instruments that put in place for various different periods of time. For example, a first period of time may correspond to that period of time the executive works prior to retirement and the second period of time may correspond to that period of time the executive works after retirement. There may be up to “N” different periods of time as may be necessary or preferred to structure and given benefit package.

An embodiment of the present invention places into effect a first product 323 that pays a benefit in the first period of time and a second product 324 that pays a benefit in a second period of time wherein the second period of time may correspond to a postretirement period. Up to “N” different products 329 may be used to structure the benefit package. In this embodiment, first product 323 may terminate at the commencement of the postretirement period and second product 324 may never mature into a benefit paying product, if, for example, the first product is life insurance and the insured under first product 323 becomes deceased in the first period. When “N” products 329 are implemented, various other designated products may be utilized at various time periods in accordance with the needs of the benefit plan for a given person or group. It is also understood that one product could be designed to have component parts that would act and interact in the same manner as the multiple products, above.

Employer data 305 is the type such as, for example, copies of all employee benefit plans, assumptions: pertaining to salaries and salary increases; as to discount rates, mortality rates, annuity rates, marginal income tax rates, pension plan variables, investment yields, variables relating to designs of survivor benefit plans and such other information and data as is necessary in view of the nature or the employer and the plan designs it institutes. Employee data 308 may include that data such as, for example, name, address, date of birth, social security number, gender, date of hire, marital status, base compensation and bonus assumptions, options and incentive based compensation assumptions, commissions, spouses date of birth, employee elections under his benefit plan, and such other data in view of the nature of employee and the benefits opted for and/or designed into the plan. Employee data 309 may also include medical underwriting data as is known in the art.

Aggregated data base 310, receives data from benefit request 300, employer data 305 and employee data 308. Benefit design software 320 utilizes data from aggregated data base 310, mortality data base 321 and contract data base 322 to design an appropriate benefit package. Mortality data base 321 may be employer specific namely when it is populated sufficiently by sufficient employee information to provide the ability to accurately model and remodel benefit plans or if not of sufficient size may incorporate generic mortality tables into mortality data base 310 or some combination of company specific and generic data bases. Contract data base 322 holds all financial and other instruments of the employer and those aggregated from outside sources that may have been entered into by the employer and/or employees or may otherwise be made available to design the subject benefit plans. In a preferred embodiment, financial service products and other contracts may include life insurance contracts would be aggregated into the data bases. And even more preferably, the financial services products, contracts and/or life insurance contracts may include contract I 323, contract II 324 and/or up to contract “N” 329, which are coupled together for each benefit plan designed.

Contract I 323 may be a life insurance policy that is written for an employee's benefit plan such that it is effective when the employee starts work and is active and covers a first period of time; this first period of time, for example, may be the time period up until this employee retires. Contract II 324 may be a life insurance policy that is written for the same employee's benefit plan and is effective only upon commencement of a second time; this second period of time, for example, may be represent a time period commencing upon the retirement of the employee. Additionally up to “N” contracts 329 may be utilized to design an effective benefit plan which may further include, for example, a second to die life insurance policy for a spouse, which may be effective in yet a third time period or in any one of the foregoing “N” time periods. Life insurance policies 323 and 324 are preferably term insurance policies but could be other types of insurance, annuities, other financial instruments or combinations of the foregoing. Benefit plans are not limited to coupling two financial instruments, contracts or life insurance policies and may couple up to “N” of such instruments as may be desirable in structuring an appropriate benefit plan. Contracts 323 and 324 are coupled such that the two operate together to fund the benefit plan notwithstanding that contract 323 may expire upon the effective date of contract 324; as pertains to the example where contract 323 and 324 are term life insurance policies, if the employee becomes deceased in period I, than policy 324 terminates and upon termination of period I, policy 323 terminates. Various combinations of financial instruments and policies are contemplated by the present invention as are more fully set forth in the Summary of the Invention, the drawings, specification and as understood by someone skilled in this art.

Returning to FIG. 3, Benefit Design Software 320 interfaces with Administration Software 330 which may among other aspects manage the benefit plans designed by BDS 320. For example, AS 330 may make payments to contracts I 323, II 324 and/or “N” 329, as well as receive payments/benefits from the companies issuing such contracts. AS 330 interfaces with employee data base 331 which aggregates information and records related to the employees of the company including tracking employee contributions from employee contributions data base 332, if any. AS 330 also interfaces with employer data base 333 which contains various information and employer records including a module 334 which tracks the employer contributions to the employee benefit plans, if any.

AS 330 additionally provides means to pay any benefits to beneficiaries 340, whether they be to employees, their heirs, the employer or combinations thereof.

Having described in detail the preferred embodiments of the present invention, including its preferred functionality and modes of operation, it is to be understood that this operation could be carried out with different elements, steps and systems. The preferred embodiments are presented only by way of example and are not meant to limit the scope of the present invention which is defined by the following claims.

What is claimed is:

1. A funding method for post retirement benefits [for an employee], comprising:
(a) providing a funding system that includes implementing first and second life insurance policies each of which pays a benefit;
(b) entering into said first and second life insurance policies by the owner wherein the first insurance policy provides a benefit for that period of time that corresponds to the pre-retirement of an employee and the second life insurance policy pays a benefit only during that period that corresponds to the post retirement period of that employee,
(c) structuring the first and second life insurance policies such that the second policy expires upon death of the insured and the owner is not required to accrue a liability for the death benefit of the insured,
(d) effecting payments of said first and second life insurance policies in said first period, wherein the owner of the life insurance policy is entitled to the benefit at the beginning of the second period based upon the death of the insured.

2. A funding method of claim 1, further including supplying the requisite variables for entry into a computer readable medium, whereby instructions operate on said variables to determine the type, cost and terms for the life insurance policies that will produce the desired benefit.

3. A funding method of claim 2, where in the type of life insurance policies are selected from the group consisting of term insurance, whole life insurance, variable life insurance, split dollar life insurance and combinations thereof.

4. A funding method of claim 3, where in the benefits are paid to the employer.

5. A funding method of claim 4, wherein at least a portion of the benefits are pooled by the employer to fund post retirement benefits of retired employees not including the insured.

6. A funding method of claim 3, wherein a portion of the benefits are paid to the employee or his heirs and the remainder to the employer.

7. A method of providing funding to pay future benefits of a defined benefit participant, comprising:
(a) Coupling first and second financial products wherein the first product provides a benefit for a first period and a second product provides a benefit for a second period;
(b) wherein the second product is in force in the first period but does not pay a benefit until the second period,
(c) further providing, that should the first product mature upon an event happening to participant in the first period, the second product is voided.

8. The method of claim 7, wherein the second product is selected from the group consisting of annuities, variable life insurance, whole life insurance and/or term life insurance.

9. The method of claim 7, wherein the first and second products are term insurance policies.

10. The method of claim 7, wherein the second product continues to be in force upon the expiration of the first period.

11. The method of claim 10, wherein the first product expires at the end of the first period.

12. The method of claim 7, wherein at least one of the products matures in either the first or second periods.

13. The method of claim 7, wherein the beneficiary of the products is the owner.

14. The method of claim 13, wherein the owner of the products is an employer.

15. The method of claim 13, wherein the owner of the product is an employer and the beneficiary is the employee's heir(s).

16. The method of claim 13, wherein the owner of the products is an employer and the beneficiary is both the employer and the employee's heir(s).

17. The method of claim 13, wherein the owner of the products is an employer and the beneficiary is the employer, further including using the benefits to fund post retirement benefits of other employees of the employer.

18. The method of claim 13, wherein the benefit is paid in the second period.

19. The method of claim 7, wherein the benefit is used to fund a post retirement benefit.

20. The method of claim 7, wherein the benefit is used to fund a pension plan.

21. The method of claim 7, wherein the benefit is used to fund an executive compensation package.

22. The method of claim 18, wherein the executive compensation package is a post retirement package that includes a non-compete provisions.

23. The method of claim 18, wherein the executive compensation package that requires employees to perform consulting services during postretirement years.

24. The method of claim 7, wherein the first product generates earnings that exceed the cost of the product.

25. The method of claim 17, wherein said earnings are accrued in the first period.

26. The method of claim 17, wherein the earnings are paid to the owner of the policy.

27. The method of claim 17, wherein the earnings are paid to both the owner and the beneficiary of the policy.

28. The method of claim 24, wherein the earnings are not paid until commencement of the second period.

29. The method of claim 28, where in the earnings are paid over a set term of years in the second period.

30. The method of claim 28, wherein the earnings are paid over the life of the beneficiary.

31. The method of claim 24, wherein at least a portion of the earnings are paid in the first period.

32. The method of claim 24, wherein additional payments are generated by the products in the second period and a payment in additional to that which is paid in the first period is paid in the second period.

33. The method of claim 7, wherein the owner of the products has no liability under the products to the participant.

34. A computerized system for generating a benefit plan based upon preferences of a benefit plan participant and presenting via a computerized network to its user, a benefit plan for said participant, comprising the steps of:
(a) prompting the user for at least one benefit plan parameter via at least one computer interface to formulate a benefit request;
(b) interfacing with from the group consisting of the benefit request, employee data, employer data; mortality data base, contracts data base or combinations thereof, to obtain data for input into benefit design software;
(c) applying a plurality of benefit design rules to the at least one benefit parameter and said resultant input from said interfacing step; and
(d) generating a benefit design plan based upon the performance of steps (a) and (c).

35. A computerized system as in claim 34, further including the step of providing administrative software for interfacing with said contracts data base, employer data base and employee database, wherein the individual benefit plans are administered.

36. A computerized system as in claim 35, wherein said administrative software interfaces with the contracts in said contracts data base for purposes of making and receiving payments from said contracts.

37. A computerized system as in claim 36, wherein said administrative software may further include interfacing with the beneficiaries of said contracts.
